(19) United States
(12) Patent Application Publication
(10) Pub. No.: US 2014/0311201 A1
(43) Pub. Date: Oct. 23, 2014

(54) METHOD FOR REMOVAL OF TOXIC WASTE FROM TIMBER

(71) Applicant: SOLRAY HOLDINGS LIMITED, Christchurch (NZ)

(72) Inventor: Christopher Francis Bathurst, Christchurch (NZ)

(73) Assignee: SOLRAY HOLDINGS LIMITED, Christchurch (NZ)

(21) Appl. No.: 14/356,046

(22) PCT Filed: Nov. 5, 2012
(86) PCT No.: PCT/NZ2012/000203

§ 371 Date: May 2, 2014

(30) Foreign Application Priority Data
Nov. 3, 2011 (NZ) 596199

(51) Int. Cl. C05B 17/00

(52) U.S. Cl. CPC C05B 17/00
USPC 71/33; 422/112

(57) ABSTRACT

A flow wood processing extracting lignin from woody plant material and converting delignified cellulosic residue to crude bio-oils, that removes toxic preservative chemicals from waste timber, and provides conversion to useful or nontoxic forms. Wood is chipped and fed into a lignin extractor using ethanol at high temperatures to dissolve the lignin with counter current material contactors, heat exchangers, and a computer control system. Most of preservative chemicals likely precipitate out at this stage as a heavy sludge that can be removed. Ethanol containing dissolved lignin is removed from the lignin extractor, the dissolved lignin recovered, the ethanol recycled into the lignin extractor, and residual heat returned to the process. Delignified cellulosic pulp is removed from the lignin extractor and subjected to a milling to convert into a smooth sludge for entry to a bio-convertor by a super critical water process. The residue is prepared as a high phosphate fertilizer.

### FIELD OF THE INVENTION

The present disclosure relates to processing technology for extracting lignin from plant material and converting the delignified cellulosic residue to crude bio-oils. It also related to the removal of toxic preservative chemicals from waste timber and conversion to useful or nontoxic forms.

### BACKGROUND

The demand for oil-based transport fuels and petrochemicals is global. Air, sea and land-based transport fuels, as well as petrochemicals, are produced from fossil fuels in the form of oil, coal and natural gas reserves. Petrochemicals are feed stocks for the plastics industry as well as for the production of resins, adhesives, paints, insulation and many other related products. It is mainly the phenol and polyols recovered from fossil fuels that are the major petrochemical feed stocks used in these manufacturing industries.

It is recognized that large scale use of fossil fuels has long been a major contributor to the degradation of the global land and water environments and the accumulation of greenhouse gases in the atmosphere. The search for green energy producing technologies to replace fossil fuels has led to the use of wind and solar power, wave motion and plant biomass. Nonetheless, such uses have not yet slowed the global demand for fossil fuels and today there are serious concerns about reliable, affordable supplies of transport fuel and petrochemical feedstock. Nations seek energy security to protect their people from the consequences of severe reductions in the supply of fossil fuels, ranging from reduced transport, decreased food production, decreased heating and electricity production and manufacturing.

A major land-based renewable energy source is plant biomass. Plant biomass can be used as a feedstock for biodiesel and chemicals for a wide range of manufacturing industries. For example, the lignin in plant biomass is a natural alternative to petrochemical feed stocks used for the manufacture of resins, adhesives, insulation, plastics, and paints. The chemistry of lignin is such that it is a natural substitute for phenol and polyols. Some industries already make use of woody biomass as feed stocks; however, process costs are typically high, waste generation is high, and there is limited yield of high value products. Also fermentation of wood is difficult and slow due to lignin presence

The pulp and paper industry is largely reliant on cellulose and the removal of lignin is a major process step. However, removal of lignin in these industries is a harsh chemical process that degrades the lignin rendering lignin a low value by-product of processing and often burnt to produce heat.

Using woody cellulosic material for degradation to sugars, and allowing fermentation to bioethanol, is another growing industry but is hampered by the costs of processing wood.

Biodiesel generated using plant feed stocks suffers the problem of competing for food feed stocks. Biodiesel, also referred to as FAME for “Fatty Acid Methyl Ester” is produced from vegetable oils and animal fats, by reaction with alcohol, commonly methanol, and a base catalyze through a process called trans-esterification.

Biodiesel produced from soy, canola, palm oil and rapeseed oil generally have better cold flow properties than animal fat biodiesel. With the growth of the biodiesel industry worldwide, vegetable oil and animal fat feedstock costs have arisen and account for some 70% of production costs.

Algae, which lack lignin, are also used as a feedstock for biodiesel but suffer, particularly in temperate climates, from seasonal growth restrictions limiting available quantity of biomass and the cost of harvesting and removal of water before processing.

The crude oil produced by this technology is roughly equivalent to Texas Light sweet crude, and as such is immediately able to enter the existing infrastructure as a true alternative to any other crude oil feedstock. Other sustainable fuels such as biodiesel, ethanol, and hydrogen suffer as their introduction requires major infrastructure changes.

Timber has been used as a building material for dwellings and boats for a long time. With the increasing population, standing forests become less available as a source of construction timber and demand grew for use of faster growing varieties of wood with a greater susceptibility to decay. The need for satisfactory methods of extending the life of this wood by using suitable chemical treatment became of increasing importance especially for exterior building timber. While the use of this treated timber has taken some decades to become widespread, it has only been recently apparent after buildings reached their economic lifetime that there was a need for an end-of-life solution for the eventual redundant waste. This need is rapidly gaining importance, especially due to the recent Christchurch earthquake and also the remedial work necessary for correcting leaky homes.

The presence of certain chemicals in treated wood makes it difficult to dispose of waste easily. Traditional uses for untreated end-of—use timber can be as firewood, garden mulch, or similar low value destinations. However care must be taken to avoid toxic effluents or emissions. The normal recommendation is to dispose of the treated timber in a landfill. Due to the pressure on landfills with the precautions needed for safe disposal, this option is rapidly becoming more expensive. In addition the loss of a resource and the heavy metals does create a need to recycle or reuse if at all possible.

Some work has been done to treat chemical residues from the preservation technology. One approach used for arsenic recovery from sludge in particular is to treat with a caustic solution. It appears that this approach may not be completely satisfactory but in any case it is specific to the treatment of CCA type sludges, but not for general use for treated timber. One problem for this approach would be the timber would be left with a caustic residue which would also be a problem.

### OBJECT OF THE INVENTION

It is therefore an object of the invention to provide a process of extracting lignin from plant biomass to remove most of the preservative chemicals and recover the lignin, or to at least provide the public with a useful choice.

### BRIEF SUMMARY OF THE DISCLOSURE

Some embodiments of the present disclosure comprise a lignin extractor capable of processing wood chips to remove most of the preservative chemicals and recover the lignin as a solution in a suitable solvent and a bio-converter that uses a super critical water process to convert the cellulosic waste to produce biocrude. The entire process leaves a sludge which is converted to a high phosphate fertilizer. Re-usable solvents are used to extract lignin and supercritical water to produce biocrude. Remaining preservative chemicals, if any, can then be removed from the oil.

The preferred initial biomass starting point for the extraction of natural lignin can be wood from forest plantations, including but not restricted to pine, salix, and eucalyptus, wood process waste from pulp and paper mills and sawmills, and urban woody biomass. The lignin extraction process can use ethanol or related solvents to dissolve the lignin. The lignin can remain natural and is not degraded by the process. Thus, the lignin can be more readily used as a substitute for industrial products used in the petrochemical industry.

A super critical water process can be linked directly to the cellulosic wood waste to produce a crude oil which can then be distilled to yield a range of high value chemicals, oil and transport fuel, products.

The invention provides an integrated method for the processing of woody plant biomass comprising:
(a) treating wood chips with solvent solution in a unit to extract lignin, generating a black liquor;
(b) separating the majority of the preservative chemicals as a sludge;
(c) separating the lignin from the aqueous ethanol solution;
(d) removing cellulosic residue generated after the lignin extraction;
(e) producing a slurry from the cellulosic residue;
(f) feeding the slurry to a bio-convertor to convert the cellulosic and other cellular biological material into a hydrocarbon oil sludge;
(g) cooling the hydrocarbon sludge to ambient temperature; and
(h) recovering bio-crude from the hydrocarbon sludge by extraction, and recovering the remainder of the preservative chemicals from the bio-crude.

Preferably the black liquor is used to heat ethanol solution entering the unit.

More preferably the ethanol from the black liquor is recovered and recycled.

The heat from the hydro carbon oil sludge is preferably used to heat additional slurry entering the bio-converter.

Preferably the method includes drying of residual sludge to produce high phosphate fertilizer. It may be dried on a heated auger conveyor whereupon liquid both drains from the sludge and is vaporized.

The vaporized liquid is may be drawn into a cooler for partial condensation.

Light hydrocarbon from the condensed vapour and liquid drained from auger may be recycled.

The woody biomass is selected from the group consisting essentially of plantation forestry of both soft woods such as pinus, and hardwoods such as eucalyptus and salix, plantation crops such as vineyards, orchards, palm oil plantations, grasses, sawmills, wood fibre and urban waste.

The ethanol may be aqueous and 70% more or less mixture with water.

The temperature in the unit may be above 180° Celsius and the pressure is at least 18 bar.

Ethanol may be recovered from the black liquor with minimal loss.

Lignin may be recovered from the black liquor by precipitation.

The precipitation may occur by adding additional aerated water to the black liquor using venturi mixing valve, whereby the lignin forms large crystals and float to a liquid surface. Alternatively the precipitation may occur by distillation of solvent from the black liquor thereby concentrating the lignin into the remaining water causing precipitation.

The cellulosic residue may be reduced to slurry by milling and mixing with suitable carrier powders.

The carrier powders may be selected from the group consisting essentially of salts of sodium, potassium and calcium as well as other carbohydrates such as algae, sugars, keratin, chitin, and collagen.

Near supercritical water may be produced in the bio-converter using residual heat from the bio-converter product.

The temperature of the water is preferably below 400° C. and the pressure is preferably below 350 bar.

The bio converter may comprise co-axial annular pipes with an outer pipe being rated for higher pressure than the inside pipe, the inside pipe being configured for carrying feed through the outer pipe.

A catalyst may be mixed with the incoming feed and is preferably less than 5% of sodium carbonate.

Preferably recovering the bio-crude comprises extracting the bio-crude in a counter current solvent extraction plant.

The solvent that may be used in the extraction plant is preferably a light hydrocarbon solvent residue, which can include a light distillate from bio-oil recovered from earlier production from the bio-converter.

The bio-convertor residue after having removed the bio-oil from the extraction will include a sludge saturated in water and light hydrocarbon solvent. This may be separated by a dryer conveyor to recover the light hydrocarbon residue for reuse.

The invention also provides a method for the processing of plant biomass comprising:
(a) extracting lignin from plant biomass using a solvent to generate a black liquor;
(b) recovering the majority of the preservative chemicals as a sludge from the black liquor;
(c) removing cellulosic residue generated after the lignin extraction;
(d) separating the lignin from the black liquor;
(e) producing a slurry from the cellulosic residue;
(f) feeding the slurry to a bio-convertor to convert the cellulosic and other cellular biological material into a hydrocarbon oil sludge;
(g) recovering bio-crude from the hydrocarbon sludge by extraction, separating remaining preservative chemicals, if any, from the bio-crude; and
(h) sending the residual sludge to a fertilizer plant to recover high phosphate fertilizer product.

The fertilizer plant may comprise a drying conveyor for use in drying fertilizer and a vapour recovery section for use in recovering liquid vaporized during drying.

The vapour may include hydrocarbon.

The fertilizer may comprise potassium, magnesium, nitrates and other valuable elements.

The invention also provides a method for the processing of plant biomass comprising:
(a) extracting lignin from plant biomass using a solvent to generate a black liquor;
(b) separating the lignin from the black liquor;
(c) removing cellulosic residue generated after the lignin extraction;
(d) producing a slurry from the cellulosic residue;
(e) feeding the slurry at high pressures to a bio-convertor to convert the cellulosic and other cellular biological material into a hydrocarbon oil sludge;
(f) adjusting and equalization of pressures across valves in conditions of high gaseous content, by installing equalization cylinders upside down to enable surplus gas to be rapidly flushed out;
(g) controlling valves proximate the bio-converter to rapidly open valves at the instant of minimum pressure difference between opposite sides of valves; and
(h) recovering bio-crude from the hydrocarbon sludge by extraction. It may further comprise sequentially operating equalization cylinders having slave pistons.

The invention also provides a method for the processing of plant biomass comprising:
(a) extracting lignin from plant biomass using a solvent to generate a black liquor, the wood chips being fed to a top inlet of a counter current extraction column comprising a series of vertically aligned valves, and the solvent being fed into a bottom inlet of the counter current extraction column, the valves being operated sequentially to transfer wood chips down the column while providing cooking periods for extracting lignin;
(b) opening a containment valve disposed at the top of the counter current extraction column, above a valve housing a top level cooking chamber of the column, to feed wood chips to the top inlet;
(c) opening a containment valve downstream of valve that houses a bottom cooking chamber of the counter current extraction column, to remove pulp;
(d) separating the lignin from the black liquor; and
(e) recovering and recycling the solvent from the black liquor.

Alternatively the column of a series of vertically aligned chambers and valves may be separated into individual chambers and valves arranged as a row performing essentially the identical process but in a different configuration.

The invention also provides a plant for processing plant biomass comprising:
(a) an extraction unit for extracting lignin from plant biomass;
(b) a high pressure bio-converter reactor for converting residue from the extraction unit;
(c) a plurality of pressure equalization cylinders fluidly connected to bio-converter;
(d) a control system for controlling valves proximate the bio-converter to rapidly open valves at the instant of minimum pressure difference between opposite sides of the valves; and
(e) a recovery section for recovering bio-crude from the hydrocarbon sludge by extraction. The invention also provides a method of removing toxic preservative chemicals from waste timber and conversion to useful or non toxic forms comprising processing woody plant material as defined above and in addition, ensuring the chemical is disposed by conversion to oil, and the heavy metal constituent separated out from the lignin and oil for upgrading and recycling back to be reused as new timber preservative.

The routes by which the process will effectively remove the preservative will vary according to the type of the chemical.

The first step in the process is that of solubilisation of the lignin from the wood by high temperature high pressure ethanol or similar solvents including but not limited to methanol and acetone. It is highly likely that all the preservatives listed will be precipitated out as sludge but depending on the preservative chemical may be solubilised in this process step and become part of the black liquor. At the next stage the lignin is precipitated from the solution. It is likely that the remaining preservatives will remain in solution at this stage as they have a lower molecular size than the typical lignin molecule. If this in fact occurs, then after separation of the lignin from the liquor it will be straight forward to then precipitate out the remaining chemicals for recycling.

If the chemical is such that it might come out with the lignin, then other separation techniques can be used to effect removal. These include pH adjustment and removal while the lignin is still in solution, or addition of a further solvent designed to ensure the preservative remains in solution while the lignin is precipitated. These techniques are well known to persons experienced in this field.

Some chemicals are likely to have become attached to the remaining cellulose from the first step. These chemicals will remain with the cellulose during the washing, transport, and milling stages. Then when processed by the supercritical reactor, the cellulose will be converted to hydrocarbon oil by removal of the oxygen atoms from the molecule. The organic forms of the preservative chemicals will also be converted to hydrocarbons and join the crude oil along with the conversion of the chlorinates and other halogens to compounds with sodium. Subsequently the new forms of the heavy metals will be separated out from the oil by standard extraction techniques well known to chemists experienced in these techniques.

### BRIEF DESCRIPTION OF SEVERAL VIEWS OF THE DRAWINGS

FIG. 1 is a simplified process flow diagram showing a process for use in extracting lignin from wood chips for various embodiments of the present disclosure.

FIG. 2 is a simplified process flow diagram showing a process for use in separating lignin from solvent and recycling solvent for various embodiments of the present disclosure.

FIG. 3 is a simplified process flow diagram showing a process for use in converting organics to oil sludge for various embodiments of the present disclosure.

FIG. 4 is a simplified process flow diagram showing a process for use in extracting oil from oil sludge for various embodiments of the present disclosure.

FIG. 5 is a simplified process flow diagram showing a process for use in separating residue and drying to generate fertilizer for various embodiments of the present disclosure.

FIG. 6 shows an alternative arrangement for the lignin extractor to that shown in FIG. 1. Instead of being vertically aligned the extraction chambers, items 1,2,3,4 and 5, may also be arranged in a horizontal row which are connected by pumped piping for transferring the solvent and black liquor.

### DETAILED DESCRIPTION

In the present description, certain specific details are set forth in order to provide a thorough understanding of various embodiments of the disclosure. However, upon reviewing this disclosure one skilled in the art will understand that the various embodiments disclosed herein may be practiced without many of these details. In other instances, some well-known structures, devices, control system configurations, instrumentation, valves, and other equipment and operations, and materials and compositions associated with lignin extraction, plant operations, and conversion of cellulosic residue to crude bio-oils, have not been described in detail to avoid unnecessarily obscuring the descriptions of the embodiments of the disclosure.

It should be understood that the terms “a” and “an” as used herein refer to “one or more” of the enumerated components. The use of the alternative (e.g., “or”) should be understood to mean either one, both, or any combination thereof of the alternatives. As used herein, the terms “include” and “comprise” are used synonymously.

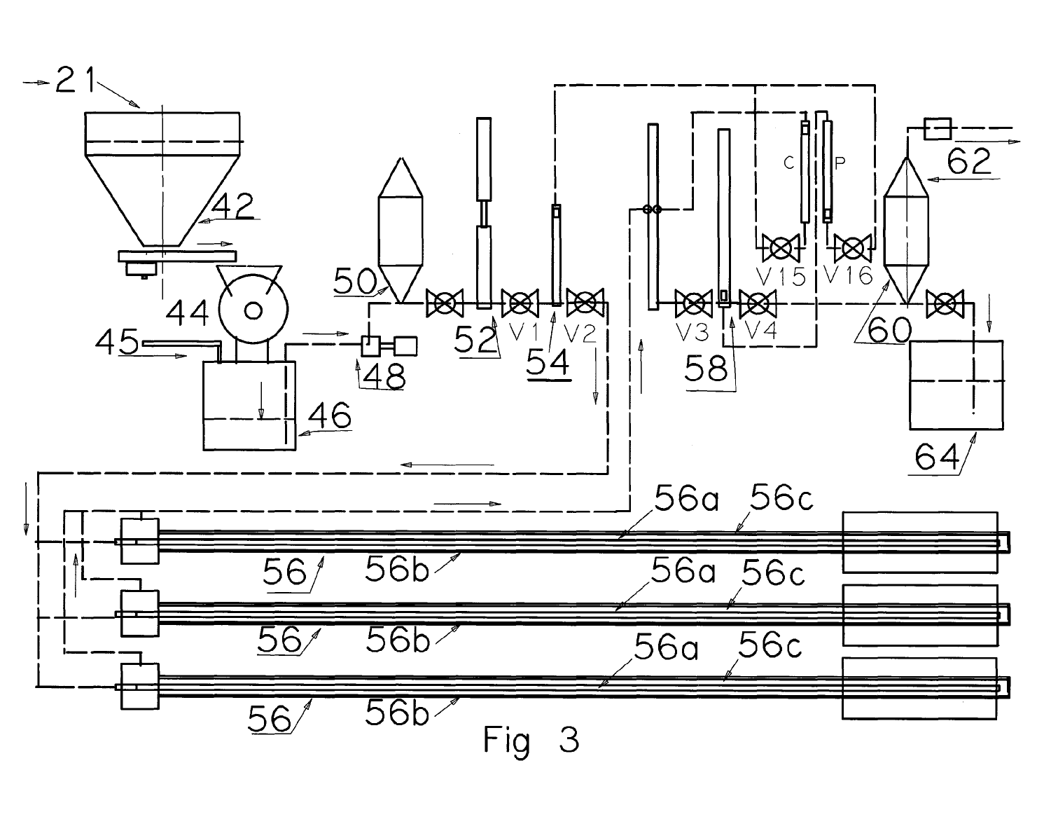

Various embodiments in this disclosure are described in the context of using woody biomass or wood chips as a feed stock. However, as will be understood by those skilled in the art after reviewing this disclosure, other plant biomass, or materials, may be suitable for processing in one or more sections of the processes and plants described herein, such as, for example, those generally illustrated in FIGS. 3, 4 and 5. Such other materials can include, for example, without limitation, algae, kelp, cellulose, sewage sludge, dry cleaning sludge, herbicides, pesticides and water toner (such as from Xerox process), all of which can produce crude hydrocarbon oil.

In various embodiments of the present disclosure discussed herein, unless the context indicates otherwise, the process steps can be controlled by one or more control systems, as will be understood by those skilled in the art after review of this disclosure. The control systems can comprise one or more processors, memory(s), display devices, and communication ports, and be capable of use for automated or manual actuated control or combined automated and manual control, to control process equipment or their components, or to monitor process conditions, among other things.

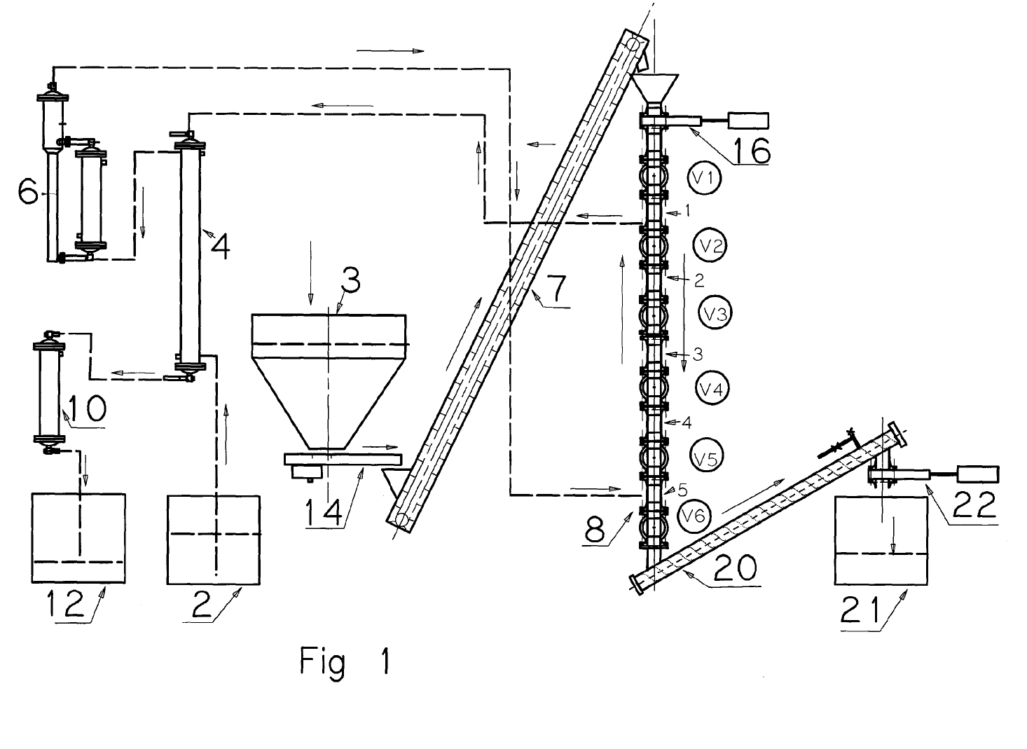

Wood used in the present disclosure can be obtained from softwood such as pinus or hardwood species such as salix from woody shrub garden waste, plantation or forest trees, forest residues and sawmill waste. Some embodiments of the present disclosure comprise a process for extracting lignin from wood chips, such as can be carried out using the equipment generally represented in the process flow diagram shown in FIG. 1.

Referring to FIG. 1, various embodiments of the present disclosure comprise using a lignin extraction column 8, and about 60% to 70% aqueous-ethanol solvent to digest lignin from the woody biomass fed to the extractor column 8. The operating pressure of the extractor column can be about eighteen (18) to twenty-three (23) bar (260-340 psi) and the operating temperature can be about one hundred and sixty-five (165) to two hundred and thirty (230) degrees Celsius. In this operating range, lignin can be efficiently soluble in the liquor, also known as black liquor, while the cellulose and hemicellulose polysaccharides can remain in the pulp fraction. In some embodiments, the operating pressure and temperature float anywhere in the range disclosed above, or can be less than the minimum stated in range or can be greater than the maximum stated in the range.

FIG. 1 details a typical system for removal of lignin from lignocellulosic biomass material through the use of a lignin extraction solution such as ethanol and a vertical extraction column 8 incorporating a series of low obstruction full flow valves. Preferably, the valves (e.g., V1, V2, V3, V4, V5 and V6) are equally spaced. The lignocellulosic biomass material will have a higher specific gravity than the lignin extraction solution. This can be achieved either by preparing the lignocellulosic biomass material to have a greater specific gravity or by preparing the lignin extraction solution to have a lower specific gravity. The lignocellulosic biomass material is typically introduced into the top of the vertical extraction column 8 and valves (e.g., V1-V6) are sequenced to permit the staged opening of every second valve to effect a gradual sequential movement downward of the wood chips through the lignin extraction solution. At the same time, the solvent is introduced by being pumped into the bottom of column 8 and travels upwards through the wood chips to the top. This movement is also effected when every second valve except for the highest and lowest valves in the vertical column is opened. After a period of consolidation, which can be for example 10 minutes, the open valves close, every other second valve opens to create a new series of double chambers, and the process is repeated. The counter-current flow between the lignocellulosic biomass material and the lignin extraction solution results in a cleansed cellulosic biomass material at the bottom of the column, and a lignin extraction solution having a high concentration of lignin at the top of the column. Following this lignin removal process, the lowest valve in the vertical column can be opened to deposit the cellulosic biomass material and the vacated space in the column can be filled with lignin extraction solution. In a similar manner, an outlet valve in the top chamber under valve V1 can be opened to withdraw the extracted lignin in the solution, which can be referred to as “black liquor.” When empty, the pressure in the top chamber is reduced to atmospheric so the top vacated space can be filled with fresh woody material for lignin removal.

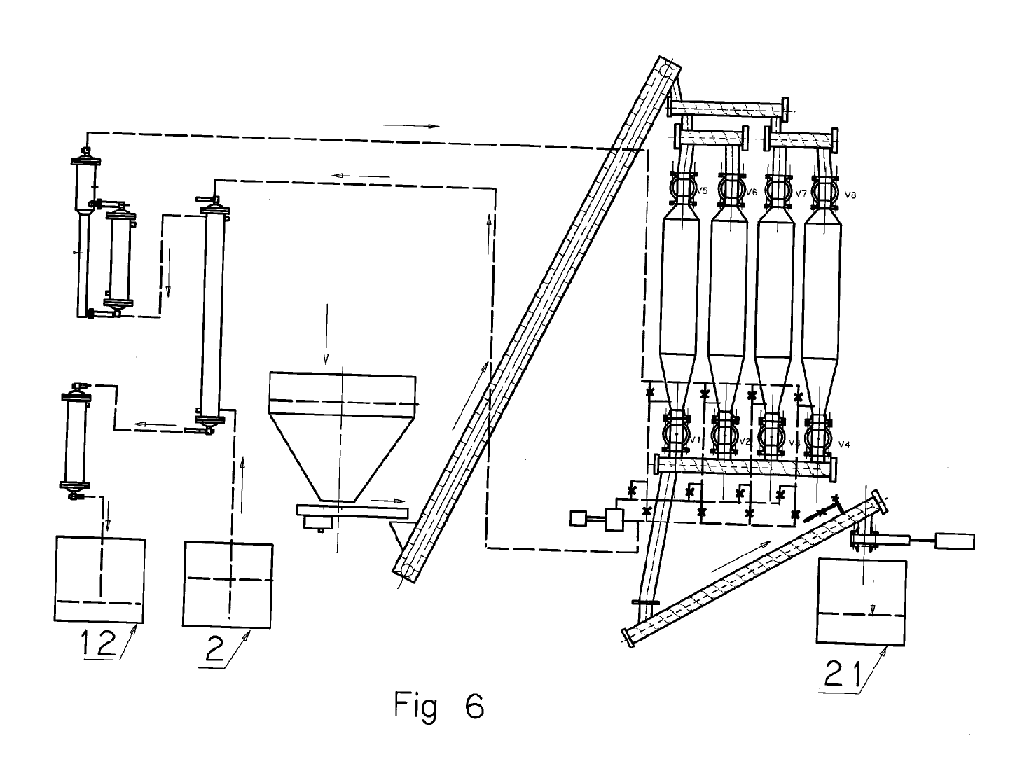

The alternative option instead of chambers arranged or stacked one on top of the other can be separated and formed in a horizontal row of chambers side by side with a piping and pump configuration to effect the transfer of liquor in the same process as the preferred option. This arrangement is shown in FIG. 6.

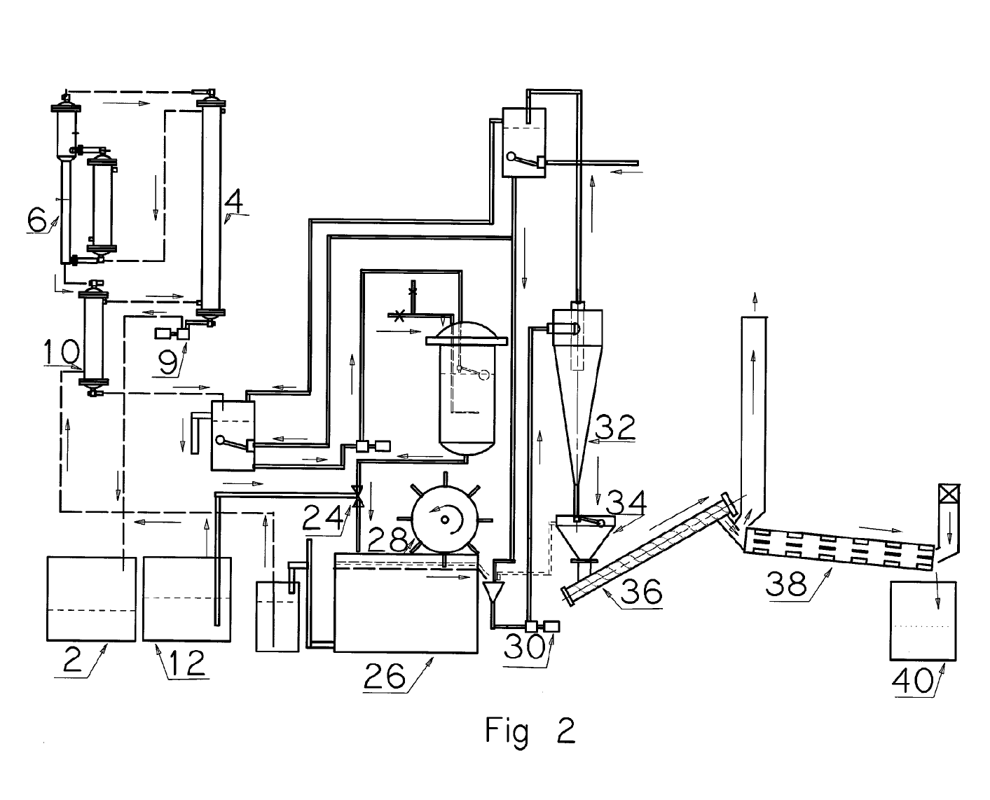

Referring to FIG. 2, after removal of the black liquor from the pulp through the extractor column 8, lignin can be recovered from the black liquor using a venturi mixer 24. This can involve introducing a stream of black liquor from tank 12 into a rapidly moving jet of aerated water. It has been noted by others skilled in the art in the relevant field that the mixing of black liquor with water can cause precipitation of the lignin in particles. However this can result in a fine colloidial suspension of lignin particles which are difficult to either float to the surface or to sink to the bottom. If the water is introduced as a jet of aerated water the lignin particles can be of a larger size which avoids the colloidial condition. The mixture can then flow to a flotation tank 26 at a relatively slow speed with the aerated water with bubbles attached to the lignin particles enabling efficient flotation of the lignin particles in flotation tank 26.

Water with dilute ethanol can be withdrawn from the bottom of the floatation tank 26 and re-circulated in the process along with a small residual of lignin which failed to float. During re-circulation, ethanol can be distilled from the water and lignin in a heater 6. The lignin particles can be recycled with the relatively pure water and to re-enter the aeration vessel, then the venturi mixer for a second chance to be floated off and recovered in the flotation tank 26.

Again, referring to FIG. 1, in operation in various embodiments of the present disclosure, the wood is chipped before processing starts. In some embodiments, wood chips can be received in a field dry condition with a size range of about 2 mm to 20 mm. In some embodiments, the lower limit of the size range is less than or greater than 2 mm, and/or the higher limit of the size range is less than or greater than 20 mm. In some embodiments, the size range itself is less than 18 mm and in some embodiments the size range itself is greater than 18 mm. The wood chips can be loaded into a wood chip feed bin 3, which in some embodiments, may be one (1) cubic meter, while in other embodiments, may be greater or less than one (1) cubic meter. A vibrating feeder 14 and chip elevator 7 can operate intermittently, as may be required by the process, to convey discrete charges of these wood chips to the top of the extraction column 8.

The extraction column 8 can be composed of a series of large valves V1, V2, V3, V4, V5 & V6 separated by short spools, or chambers 1′, 2′, 3′, 4′ & 5′ of the same diameter pipe. While the present extraction column is 150 mm diameter, there is no restriction to the size and the design can be scaled up to suit any preferred plant production requirements. In some embodiments, the chambers 1′, 2′, 3′, 4′ & 5′ are jacketed and lagged to maintain the process temperature, as discussed above, in the extraction column 8.

In some embodiments, a containment valve, such as a knife valve 16, is provided at the top of the extraction column 8, above the top valve (e.g., valve V1), to provide an extra fully enclosed chamber above the top valve V1, and another containment valve, such as a knife valve (V22 illustrated in FIG. 1, can be provided below the bottom valve (e.g., valve V6), to provide a fully enclosed chamber at the bottom, to help prevent continual spillage and leakage from the top and bottom of the extraction column 8. In the particular embodiment shown in FIG. 1, a short enclosed auger conveyor is provided between valve V6 and valve V22 in order to save height, and also to provide a wash conveyer. By this embodiment, the outgoing pulp can be washed of surplus ethanol by a backwash of fresh water while being conveyed up to V22. This embodiment is not essential but is a preferred option. The top knife valve 16 is opened only after the top valve V1 is opened in order to load wood chips into the extraction column 8. The bottom knife valve 22 is opened only after the bottom valve V6 is opened to remove pulp from the extraction column 8.

In some embodiments, the top V1 valve is opened by control system along with the third valve V3 and fifth V5 valve in the sequence. Knife valve 16 is then opened and an initial charge of wood chips can fall into the first chamber 1′. At the same time any material in the second 2′ and fourth 4′ chambers drops down one chamber and ethanol/black liquor rises into those chambers. Those valves, including the knife valve 16 can then be closed. Hot ethanol can then be injected into the top first chamber 1′, to bring the pressure up to operating pressure (as discussed above), and thereafter, valves remain closed during a cooking period. In some embodiments, the duration of the cooking period can be about 10 minutes. In other embodiments, the cooking period can be longer or shorter than 10 minutes. Ethanol can then be temporally removed from the bottom chamber, the fifth chamber 5′, to drop the pressure there. The second V2, fourth V4, and sixth V6 valves can then be open and material in the first 1′, third 3′ and fifth 5′ chambers each drop down one chamber. Note that the material dropping out of the final fifth 5′ chamber can empty into a bath of water. All valves can then be closed and hot ethanol can be re-injected into the fifth 5′ chamber to bring up to full operating pressure. Again, the valves can remain closed during a cooking period. Finally, all ethanol containing dissolved lignin (also referred to herein as “black liquor”) can be removed from the top first 1′ chamber and the pressure can be reduced to close to atmospheric pressure. Thereafter, the cycle described above can be re-initiated.

Hot black liquor discharged from the extraction column 8 can progress through the heat recovery section for cooling by entering the heat exchanger 4 at the top, in counter flow to the fresh ethanol, then the cooler 10. The pressure of the black liquor is reduced to atmospheric in the cooler, and eventually the low temperature black liquor is unloaded for storage in the black liquor container 12. Also fresh ethanol can be loaded from the ethanol container 2 and progresses first through the heat exchanger 4 to be preheated by the outgoing black liquor, then second into the heater 6 where it is pressurized to operating pressure and heated to the full operating temperature ready for loading into the extraction column 8.

At the bottom end of the extraction column, the spent wood chips without the lignin, can progress up the wash conveyor by auger 20 until they are discharged washed into the pulp product container 21.

Some embodiments of the present disclosure comprise a process for separating lignin from the extraction medium (which in the above example, is ethanol), and recycling the extraction medium, such as can be carried out using the equipment generally represented in the process flow diagram shown in FIG. 2.

Referring to FIG. 2, in some embodiments of the present disclosure, black liquor (in storage container 12), which comprises lignin dissolved in ethanol, can be sucked or pumped up into a Venturi mixer 24. Water aerated under pressure forms a jet in the venturi 24 which can interact with the black liquor. The lignin can be forced out of solution and enter the flotation tank 26.

In the flotation tank 26, air contained by the water can form tiny bubbles which carry the lignin crystals up to the surface of the floatation tank 26 where a paddle mechanism 28 can scrape the lignin sludge 26′ out of the flotation tank 26 into a pump 30, along with fresh water for washing.

The pump 30 can convey the water plus lignin crystals from the flotation tank 26 into a hydro cyclone 32. The lignin crystals, now separated from the air bubbles in the hydro cyclone 32, can sink to the bottom of the hydro cyclone 32 and drain into the dewatering tank 34.

From the dewatering tank 34, wet lignin can be transferred into the dewatering auger 36, which can slowly convey the lignin out of the water and into a rotating dryer tube 38, with heated air flowing through the drying tube at temperature between 100 to 200° C., in some embodiments. Surplus water can be allowed to overflow for from the dewatering tank to the floatation tank 26 for further treatment before disposal.

The rotating dryer tube 38 can slowly rotate and convey the lignin sludge, by regularly lifting and pouring the sludge into a current of warm air, in much the same way as a clothing dryer operates. By the time the lignin reaches the lower end of the tube, the moisture has evaporated and the lignin powder can pour into the receiving product container 40.

In some embodiments, the ethanol/water mixture in the flotation tank 26 can decant out from the bottom of the tank 26 without the lignin. This mixture can be sucked first through the cooler 10 (which is at higher temperature than the mixture), then through the heat exchanger 4 in counter-flow to the black liquor, finally entering the heater 6 at the lower end. The temperature of the mixture in the heater 6 can rise until the ethanol in the mixture distils off at the top. This can be aided in part by a vacuum operation at reduced pressures of about 0.3 to 0.5 bar in some embodiments. In some embodiments of the present disclosure, the level in the heater 6 top can be controlled by detecting the level and controlling the inlet valve closed until the level drops to a low level sensor.

The distilled ethanol vapours from the heater 6 can enter the heat exchanger 4 and condense while dropping down tubes within the heat exchanger. At the lower end of the heat exchanger 4, the cooled liquid ethanol can enter a vacuum pump 9 and finally be discharged into the fresh ethanol container 2.

In some embodiments, periodically in the heater 6, the proportion of residual water can rise to a point where the proportion of water in the vapour is no longer suitable for the lignin extraction process. A control system can determine this condition by monitoring the temperature of distillation at the top of the heater, and send a control signal when a threshold temperature has been reached due to rising water level, as will be appreciated by those skilled in the art after reviewing this disclosure. In some embodiments, the threshold temperature is about 70° to 80° centigrade, when the absolute pressure in the system is about 0.5 bar to 0.7 bar. When this occurs, a valve (not illustrated in FIG. 2) can be automatically opened at the bottom of the heater and a proportion of the contents can be removed by a pump through the cooler 10 and into a header tank. The proportion of ethanol in this water can be quite low, in the range of 4% to 8%, and can thus be adequate for use in the water Venturi 24.

Some embodiments of the present disclosure comprise a process for converting the organics, such as wood pulp, to oil sludge, such as can be carried out using the equipment generally represented in the process flow diagram shown in FIG. 3.

The cellulose pulp, contained in the pulp product container 21, as delivered from the lignin extraction process, can be milled sufficiently to form a pumpable sludge at a mill 44 (see for example FIG. 3). This can be necessary as cellulose as a raw material is composed of long needle like filaments which can knit together at pipeline changes and bends.

While various embodiments of the present process provide a continuous process, they can also operate as a series of discrete charges which are periodically passed from one step to the next. In particular, the sludge can be increased in pressure in two stages (as further described below) until it is able to be forced into one of the reaction tubes 56. In the reaction tubes 56, the inlet charges are progressively increased in temperature as they move along the inner tube 56a, by heat exchange with hot product material which is also progressively moving in the reverse direction in an annular space 56c between the outer tube 56b and inner tube 56a, while cooling. Eventually the incoming sludge now at a significant temperature reaches a heater section 56′. The temperature in this section 56′ raises the sludge temperature to a reaction set point, which in some embodiments can be between about 280 to 360° C., while at the same time, the pressure, which can be at about 170 to 250 bar in some embodiments, is such that the sludge with the water is prevented from turning to steam. At the high temperature, water can change its characteristics and start to dissolve the sludge. Certain reactions then occur between the sludge and the water which generate other substances as dictated by the materials and the thermodynamic conditions in the mixture at the set point temperature and pressure. The original sludge is converted into product sludge with the main components being a hydrocarbon with a very high carbon number, carbon dioxide gas, water, and a residual series of minerals of the original constituent non-hydrocarbon elements.

Eventually the cooled product sludge exits the reaction tubes 56 still at the high pressure, and enters a decompression slave cylinder 58. After being decompressed the product sludge enters the product vessel 60 and the gases, being principally carbon dioxide, are allowed to separate from the liquids and solids. The gases exit from the top of the product vessel through a gas meter 62 to ensure volumes can be recorded and then discharged to the atmosphere.

The liquids and solids exit from the product at the bottom of the product vessel 60 and enter a sludge product container 64 to be stored for the next extraction process (as described in further detail below).

In some embodiments, due to the very high pressures in this part of the process represented generally in FIG. 3, there is a need to prevent valves from “wire-drawing” caused at the instant of just cracking open. If “wire-drawing” happens with a significant pressure difference from one side of the valve to the other, the valve can be damaged within hours. Sludge at very high speed can rush through an initial opening in valves and erode seals and hard metal rapidly. In order to protect the sludge handling valves, techniques have been employed to equalize the pressures on each side of the valve at the point in time of opening. For example, first, the pressure is roughly equalized with action by the automatic control system. Dedicated slave cylinders are used to adjust pressures on each side accurately. In particular, this automated equalization using slave cylinders can be configured as described here. However such technique is insufficient when working with certain sludges wherein there are a high proportion of solids.

Without being bound by theory, the inventor(s) hereof note that after the reaction phase in the reaction tube 56, some organic materials have been converted to simple oils and a carbon dioxide amount of as much as 55% of total product. At high pressures around 250 bar or more bar, gas can be contained in tiny bubbles in the product, and can expand greatly when the product is decompressed. Thus, in the system and methods described above for equalizing pressure across valves, the equalizing cylinders would need to be very large in order to effectively equalize pressure, which may not be practical. Alternatively, various embodiments of the present disclosure include: Employing enlarged equalizing cylinders having example dimensions of 75 mm diameter and 3 metres length for some embodiments of the present invention. In addition, the equalization cylinders can be installed upside down with the sludge inlet and outlet at the top of the cylinder to flush out free carbon dioxide, which is in reverse to normal intuitive practice. Also, a control system can be used to rapidly open valve V4 at the instant of minimum pressure difference between opposite sides of the valve. This can comprise, for example, additional pressure equalizing cylinders connected between V3 and V4 to balance out pressures during the depressurizing operation.

Without being bound by theory, in operation in a pilot plant, it was believed by observation of conditions that when the expansion was rapid enough, the adiabatic nature of the expansion caused an immediate large cooling of the gas bubbles which limits the expansion sufficiently to allow valves to open safely before the gas rapidly gained in temperature to equalize with the surrounding media. This condition did not last long and typically no longer than about 3 seconds, but was long enough for the valves to be opened before the gas started to expand while warming. If the valve V4 fails to open quickly enough, the enclosed warming gas will increase in pressure and create a pressure difference across the valve V4 just when it is required to open.

Referring to FIG. 3, in some embodiments of the present disclosure, wood pulp generated from the process illustrated in FIG. 1, and other cellulosic material (“pulp”), held in the pulp container 21, can be loaded into a pulp feed bin 42. From there, the pulp can be fed into a flour mill 44, and the flour mill can execute a hammer action selected to break up the slightly brittle cellulosic material into short pieces, which fall into tank 46.

The milled pulp feedstock in tank 46 can then be mixed with water and other thickeners as may be required, combined with a small amount of catalyst, flowing into the tank 46 from source 45, to produce a pumpable sludge in tank 46.

A feed pump 48 can periodically pump the pumpable sludge to a feed vessel 50. In some embodiments, the feed vessel 50 can be capable of containing, or be rated for, pressurization up to two (2) bar, for convenient loading of the reactor plant as the control system requires. In some embodiments, the feed vessel 50 is rated for higher pressures or lower pressures than two (2) bar. After filling, the feed vessel 50 is automatically pressurized (e.g., up to two (2) bar).

A stage one pump 52 can be loaded from the feed vessel 50 with a charge and this charge can be transferred under pressure through valve V1′ to a high pressure (HP) slave pump 54. The HP slave pump 54 can load the charge through valve V2′ at the high system pressure into a single selected reaction tube 56, while simultaneously allowing a reacted charge to flow through valve V3′ into the slave product pump (Decompression pump) 58 while still under pressure. Valves V2′ and V3′ can then be closed. The decompression pump 58 can then reduce the pressure in the pump down to near atmospheric pressure. Valve V4′ can then open and the charge can be pushed out into a product vessel 60. After settling, the product gas, which can be mainly CO2, can be allowed to be discharged through a gas meter 62. The sludge product can then be allowed to flow from the product vessel 60 into the product container 64.

As discussed previously, in some embodiments, pressure equalization cylinders are provided to ensure pressures are equalized on both sides of valves V2′ and V3′ before they are allowed to open. This can eliminate major wear by the sludge.

The number and length of reaction tubes 56 can be determined as a function of capacity of throughput required and the length of reaction time considered necessary by a user. In some embodiments, a practical number is considered to be at least nine tubes 56 each at least eighteen (18) meters long.

Each tube 56 can have co-axial walls, with an inner tube 56a of diameter 25 mm and outer tube 56b of diameter 76 mm. The feed material can enter at one end through an inner tube 56a and proceed in stages along the length to the heater end 56′. In transit, the charge will push the preceding charge in front of it.

At the heater end 56, the open inner tube 56a allows the feed material to enter the outer tube 56b which has a closed end so that the material is forced to return along the annular space 56c between the inner and the outer tubes. The heater section 56′ can be configured to heat the whole outer tube 56b in its area to set point temperature. The reactor tube 56 will heat the contents by heat exchange, and effect the desired reaction of cellulosic material and water into hydrocarbon oil sludge, as will be understood by those skilled in the art after reviewing the present disclosure.

As proceeding charges enter the inner tube 56a the material is forced to move down the inner tube 56a then back along the outer tube 56b in stages. During the time while moving, and while at rest, the heated material in the annular space between the inner tube 56a and outer tube 56b will transfer heat to the incoming material in the inner tube 56a. As the entire tube 56 can be well insulated to retain heat, most of the heat required for any one charge to reach temperature can be obtained by heat transfer from outgoing reacted material, and only a top-up heating may be required to be input by the heaters 56′. When the reacted material then leaves the tube assembly 56, it can flow out through a manifold section at the initial end of entry at a conveniently low temperature, which can be typically less than 60°. A control system can be used to control the heaters 56′ and regulate the rate of charge to the tube reactors, to suit the temperatures, pressures and cooking time as desired. In some embodiments, the variables to control around the reactor tubes 56 can thus be charge rate and heater 56′ temperature. Also, safety can be enhanced by three levels of control over temperature and pressure levels.

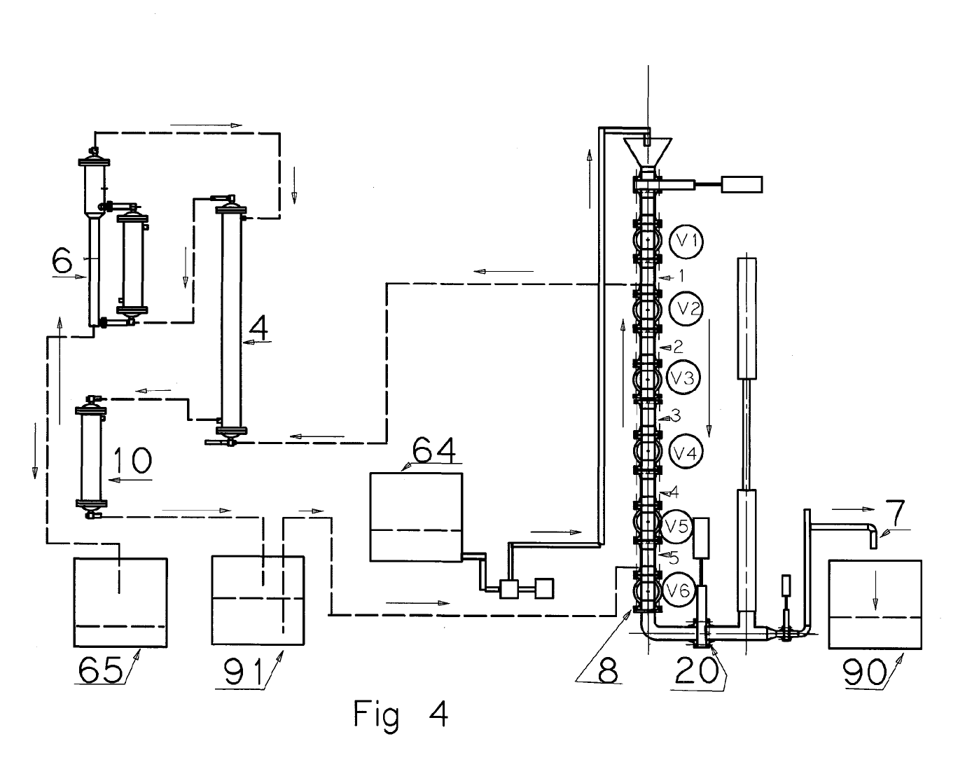

In some embodiments of the present disclosure, the process generally depicted in FIG. 3, includes the following steps: (i) The pumpable sludge from tank 46 is heated in the reactor tubes 56 at over 200 bar to a temperature above 340 degrees C. (ii) At this pressure of 200 bar, the sludge is then cooled to below 200° C. by heat exchange with incoming sludge in the reactor tubes 56. (iii) Thereafter, the sludge is returned to atmospheric pressure through decompression 58, and CO2 is allowed to vent off, as measured by gas meter 62. As generally depicted in FIG. 4, the sludge can be mixed with low carbon hydrocarbon solvent (e.g., hexane).

Without being bound by theory, the inventors hereof theorize that during process step (i) carbohydrates are converted to a mixture of acid gasses and alcohols, then during step (ii), gasses are converted to complex high end carbon solid molecules (commonly known as “kerogen” to geologists). Finally, during step (iii) lighter hydrocarbons are extracted from the high carbon broken down molecules.

Referring to FIG. 4, in some embodiments, a process is provided for extracting oil from the oil sludge, and the process can utilize some of the same plant equipment as that illustrated in FIG. 1. For large scale processing and to maximize throughput in a plant, the equipment units shown in FIG. 4 can be in addition to that shown in FIG. 1, but for smaller throughput operations, some of the same equipment may be used for lignin extraction from wood and for oil extraction from oil sludge.

In some embodiments of the present disclosure, the product sludge derived from the reactor tubes 56 rapidly settles to a heavy sludge and a water layer. The water can be decanted off the sludge which then needs to be processed with a light hydrocarbon solvent. This process can be carried out in a counter current extraction column 8′ to maximize oil extraction and minimize the required solvent use. The solvent can act on the heavy sludge and break out the hydrocarbons as lighter hydrocarbons of a much lower carbon number, typically in the C8 to C14 range. This oil laden solvent solution, called a black liquor, can then be distilled to recover the original solvent which is then returned for processing with further sludge. The crude oil remaining after this operation can then be drained off to form the product crude oil. Some residual water from the sludge can be decanted from the oil. This water will be surplus and can be sent to be reused in another part of the plant, or disposed to waste.

Referring to FIG. 4, in particular, to extract oil from oil sludge, a solvent used in the extraction column 8′ can be a light hydrocarbon solvent about hexane size. Also, a built-in control program for the same control system as used for lignin extraction can be used. If the same plant is used as shown in FIG. 1, a sludge hose 7′ needs to be connected to the outlet on a sludge container (e.g, intermediate bulk container or “IBC”), otherwise, such connection may be permanent.

To process the oil sludge, the top valve V1 of the extraction column 8′ can then be opened along with the third valve V3 and fifth valve V5 in the sequence. An initial charge of sludge can then be transferred into the first chamber 1′. At the same time any sludge in the second chamber 2′ and fourth chamber 4′ can drop down one chamber. Valves can then be close for an extraction period (which can be, for example, 15 minutes). The second valve V2, fourth valve V4, and sixth valve 6 can then be opened and material in the first chamber′, third chamber 3′ and fifth chamber 5′ can drop down one chamber. In some embodiments, when this happens, the sludge dropping out of the final fifth chamber 5′ empties into a base pipe 20′. Again, valves can then close for the extraction period. Solvent can then be injected into the fifth 5′ chamber and all solvent containing dissolved oil and black liquor can be removed from the top first 1′ chamber. This cycle can be repeated. The operating temperature and pressure range of the extraction column can be maintained at about 15 to 25 degrees C. and 0.1 to 0.4 bar.

After the black liquor leaves the extraction column 8′, it can progress through the heating section by entering the heat exchanger 4′ at the top, then the heater/distillation unit 6′. Distillation proceeds after heating to the vaporization temperature of the solvent (e.g., hexane), which can be in the range of about 80 to 95 degrees C. Black liquor is added until a level in the heater unit 6′ reaches a maximum level, based on a level sensor, and then distillation continues until a final set point temperature signifies completion of solvent distillation. When the set point temperature is reached, it indicates all solvent has been distilled and the heater product chamber is full of oil product. Oil product can be drained automatically into an oil product drum 65′ until the lower level indicator on the heater 6′ is reached. Then another charge of black liquor can be added and distillation recommences.

The distilled solvent vapours from the heater 6′ can proceed to the heat exchanger 4′ wherein they condense into liquid while exchanging heat with the incoming black liquor from the extraction column 8′. After leaving as a liquid from the bottom of the heat exchanger 4′, the solvent enters the cooler 10′ for further cooling and also storage 91′. As may be required by the process, cool solvent can be withdrawn and injected into the fifth (5) chamber of the extraction column when emptied of the proceeding charge. The solvent is thus recycled.

At the bottom end of the extraction column 8′, the spent residue without oil, can progress into the residue discharge pump and then to the container 90′, an initial fertilizer sludge container. This initial fertilizer sludge can have a residue high phosphate fertilizer with significant traces of solvent and water. The fertilizer can be extracted from the sludge to be useful, as discussed below.

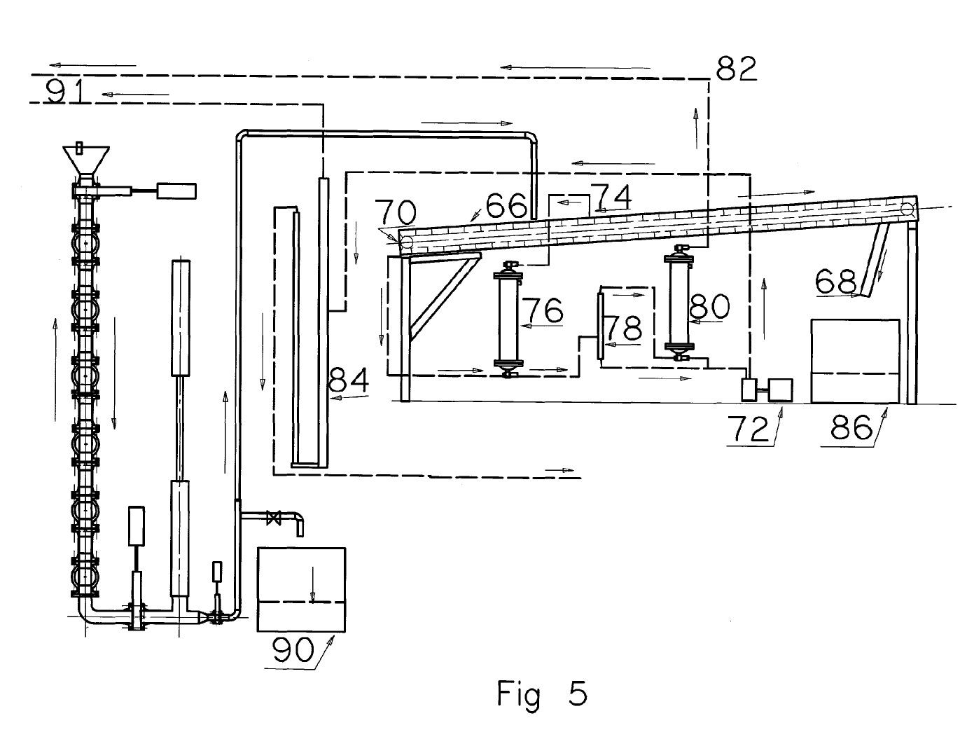

Some embodiments of the present disclosure comprise a process for separating residue from the fertilizer sludge and drying the purified material to fertilizer, such as can be carried out using the equipment generally represented in the process flow diagram shown in FIG. 5.

Referring to FIG. 5, in some embodiments, sludge residue from tank 90′ can be directed by pipe to a midpoint 66′ of a heated drying conveyor 66. An auger of the conveyor 66 can slowly move the solid sludge upwards to a delivery point 68. Meanwhile, liquids from the sludge can travel down the conveyor 66 against the auger direction to the closed bottom end 70. The liquids can be transferred through a pipe connected to the suction of a transfer pump 72.

Some solvent and water trapped in the sludge may be vaporized by the heated conveyor 66 surface and travel to a suction point 74 just higher than the initial sludge entry point 66′. The vapours can be drawn and directed to a cooler 76, and cooled by cooling water. That vapour which condenses will join the pipe towards the suction of the transfer pump 72. A small simple separation column 78 downstream of the cooler 76 can separate vapours from liquids. Liquids can join the pipe to the transfer pump 72, and vapours will enter the lower temperature chiller unit 80 so that further condensation can take place. That vapour which reaches the top of the chiller 80 will be deemed to be non-condensable gases including air, and be directed by pipe 82 to a fume ducting system. Any further condensate will join the pipe to the suction of the transfer pump 72.

After leaving the transfer pump the discharge can enter the liquid-liquid phase separation column 84. Two separate liquid phases can separate. The light hydrocarbon liquids can form a top layer, and the heavier water will be the lower layer. Water can leave the bottom of the column 84 and is directed to waste, while the hydrocarbon liquids can be directed to the hydrocarbon storage container 91′ in the extraction plant area. Meanwhile, the heated and dried sludge can reach the top of the drying conveyor 66 and drop down to the dried fertilizer product container 86 as fertilizer.

With respect to the removal of preservative chemicals from waste timber and conversion to useful or nontoxic forms the list of preservative chemicals which have been in use for treating wood is very diverse and growing. By definition a suitable chemical must first be toxic to fungi and bacteria. In addition it must be easily transportable into the pores of the wood as well as being able to fix in position and not be easily washed out of the wood. These properties make the removal of the preservative chemicals difficult to achieve.

Common preservative chemicals and their present use can be listed as below;—
Creosote. Still in common use but carcinogenic. Used for many railway sleepers.
PCP A chlorinated hydrocarbon, now banned as it contains dioxin, but much old wood can be suspected to contain this material.
TBTO Tributyl Tin Oxide. Used for boat antifouling as a marine toxin.
CCA In common use. Copper Chromic Arsenic. Cannot be burnt.
LOSP Light Organic Solvent Preservative. Contains chlorinated compounds.
CA-B Copper Azole. Also several derivatives, usually chlorinated.
Others. Propiconazole, Tebuconazole, Permethrin

All of these can be handled and rendered nontoxic in theory by the process as described above for converting cellulose to oil. The necessary extra step is to ensure the chemical is in fact disposed by conversion to oil, and the heavy metal constituent separated out from the lignin and oil for upgrading and recycling back to be reused as new timber preservative. The routes by which the process will effectively remove the preservative will vary according to the type of the chemical.

The first step in the process is that of solubilisation of the lignin from the wood by high temperature high pressure ethanol. It is highly likely that all the preservatives listed will also be solubilised in this process step and become part of the black liquor. At the next stage the lignin is precipitated from the solution. It is likely that the preservatives will remain in solution at this stage as they have a lower molecular size than the typical lignin molecule. If this in fact occurs, then after separation of the lignin from the liquor it will be straight forward to then precipitate out the remaining chemicals for recycling.

If the chemical is such that it might come out with the lignin, then other separation techniques can be used to effect removal. These include pH adjustment and removal while the lignin is still in solution, or addition of a further solvent designed to ensure the preservative remains in solution while the lignin is precipitated. These techniques are well known to persons experienced in this field.

Some chemicals are likely to have become attached to the remaining cellulose from the first step. These chemicals will remain with the cellulose during the washing, transport, and milling stages. Then when processed by the supercritical reactor, the cellulose will be converted to hydrocarbon oil by removal of the oxygen atoms from the molecule. The organic forms of the preservative chemicals will also be converted to hydrocarbons and join the crude oil along with the conversion of the chlorinates and other halogens to compounds with sodium. Subsequently the new forms of the heavy metals will be separated out from the oil by standard extraction techniques well known to chemists experienced in these techniques.

Although specific embodiments of the present disclosure have been described supra for illustrative purposes, various equivalent modifications can be made without departing from the spirit and scope of the disclosure, as will be recognized by those skilled in the relevant art after reviewing the present disclosure. The various embodiments described can be combined to provide further embodiments. The described systems, structures and methods can omit some elements or acts, can add other elements or acts, or can combine the elements or execute the acts in a different order than that illustrated, to achieve various advantages of the disclosure. These and other changes can be made to the disclosure in light of the above detailed description.

### INDUSTRIAL APPLICABILITY

The invention may be used in a number of industries where removal of chemical residues from biomass is required. The presence of certain chemicals in treated wood makes it difficult to dispose of the wood easily. For example, wood is often disposed of in landfill. However due to the pressure on landfills nowadays and the requirements for safe disposal of treated wood, the invention will be useful in treating such waste wood by removing the majority of the preservatives chemicals and other noxious chemicals and allow for safer disposal of less toxic material into the landfill. In addition the invention provides for the recovery of lignin and a bio-converter to convert cellulosic waste to produce a useful biocrude.

1. A method for the processing of woody plant biomass comprising:
(a) treating wood chips with a solvent solution in a unit to extract lignin, generating a black liquor;
(b) separating the majority of the preservative chemicals as a sludge;
(c) separating the lignin from the aqueous solvent solution;
(d) removing cellulosic residue generated after the lignin extraction;
(e) producing a slurry from the cellulosic residue;
(f) feeding the slurry to a bio-convertor to convert the cellulosic and other cellular biological material into a hydrocarbon oil sludge;
(g) cooling the hydrocarbon sludge to ambient temperature; and
(h) recovering bio-crude from the hydrocarbon sludge by extraction, and recovering the remainder of the preservative chemicals from the bio-crude.

2. A method according to claim 1 in which the solvent solution used to treat the wood chips is selected from the group comprising: ethanol, methanol or acetone.

3. A method according to claim 2 in which the solvent solution is ethanol.

4. A method according to claim 1 in which the black liquor from step (a) is used to heat solvent solution entering the unit.

5. A method according to claim 1 in which the solvent solution in step (c) is recovered and recycled from the black liquor.

6. A method according to claim 1 in which the heat from the hydrocarbon oil sludge from step (f) is used to heat additional slurry entering the bio-converter.

7. A method according to claim 1 in which residual sludge is dried to produce high phosphate fertilizer.

8. A method according to claim 7 in which the residual sludge is dried on a heated auger conveyor whereupon liquid drains from the sludge and is vaporized.

9. A method according to claim 8 in which the vaporized liquid is drawn into a cooler for partial condensation.

10. A method according to claim 8 in which light hydrocarbon from the condensed vapour and liquid drained from auger is recycled.

11. A method according to claim 1 in which the woody biomass is selected from the group consisting essentially of plantation forestry of both soft woods such as pinus, and hardwoods such as eucalyptus and salix, plantation crops such as vineyards, orchards, palm oil plantations, grasses, sawmills, wood fibre and urban waste.

12. A method according to claim 3 in which the ethanol is aqueous and 70% more or less mixed with water.

13. A method according to claim 1 in which the unit is at a temperature of about 1800 Celsius.

14. A method according to claim 1 in which the pressure is at substantially 18 bar.

15. A method according to claim 1 in which the lignin is recovered from the black liquor by precipitation.

16. T method according to claim 16 in which the precipitation occurs by the addition of aerated water to the black liquor using a venture mixing valve, and whereby the lignin forms large crystals which float to a liquid surface.

17. A method according to claim 15 in which the precipitation occurs by distillation of solvent from the black liquor thereby concentrating the lignin into the remaining water, causing precipitation.

18. A method according to claim 1 in which the cellulosic residue is reduced to slurry by milling and mixing with suitable carrier powders.

19. A method according to claim 18 in which the carrier powders a new selected from the group consisting essentially of salts of sodium, potassium and calcium and other carbohydrates such as algae, sugars, keratin, chitin and collagen.

20. A method according to claim 1 in which near supercritical water is produced in the io-convertor using residual heat from the bio-converter product.

21. A method according to claim 20 in which the temperature of the water is below about 400° C. and the pressure is below about 350 bar.

22. A method according to claim 1 in which a catalyst is mixed with the incoming wood chips.

23. A method according to claim 22 in which the catalyst is less than about 5% sodium carbonate.

24. A method according to claim 1 in which the bio-crude is extracted in a counter-current solvent extraction plant.

25. A method according to claim 1 in which the solvent used in step (h) is a light hydrocarbon solvent residue, which can include a light distillate from bio-oil recovered from earlier production from the bio-converter.

26. A method according to claim 1 in which the sludge saturated in water and light hydrocarbon solvent in the bio-convertor residue which has removed the bio-oil from the extraction is separated by a dryer conveyor to recover the light hydrocarbon residue for reuse.

27. A method for the processing of plant biomass comprising:
(a) extracting lignin from plant biomass using a solvent to generate a black liquor;
(b) recovering the majority of the preservative chemicals as a sludge from the black liquor;
(c) removing cellulosic residue generated after the lignin extraction;
(d) separating the lignin from the black liquor;
(e) producing a slurry from the cellulosic residue;
(f) feeding the slurry to a bio-convertor to convert the cellulosic and other cellular biological material into a hydrocarbon oil sludge;
(g) recovering bio-crude from the hydrocarbon sludge by extraction; and separating remaining preservative chemicals, if any, from the bio-crude, and
(h) sending the residual sludge to a fertilizer plant to recover high phosphate fertilizer product.

28. A method according to claim 27 in which the fertilizer plant comprises a drying conveyor so that the fertilizer is dried and liquid recovered during drying.

29. A method according to claim 28 in which the vapour includes hydrocarbon.

30. A method according to claim 27 in which the fertilizer comprises potassium, magnesium, and nitrates.

31. A method for the processing of plant biomass comprising:
(a) extracting lignin from plant biomass using a solvent to generate a black liquor;
(b) separating the lignin from the black liquor;
(c) removing cellulosic residue generated after the lignin extraction;
(d) producing a slurry from the cellulosic residue;
(e) feeding the slurry at high pressures to a bio-convertor to convert the cellulosic and other cellular biological material into a hydrocarbon oil sludge;
(f) adjusting and equalization of pressures across valves in conditions of high gaseous content, by installing equalization cylinders up side down to enable surplus gas to be rapidly flushed out
(g) controlling valves proximate the bio-converter to rapidly open valves at the instant of minimum pressure difference between opposite sides of valves; and
(h) recovering bio-crude from the hydrocarbon sludge by extraction.

32. A method for the processing of plant biomass comprising:
(a) extracting lignin from plant biomass using a solvent to generate a black liquor, the wood chips being fed to a top inlet of a counter current extraction column comprising a series of vertically aligned valves, and the solvent being fed into a bottom inlet of the counter current extraction column, the valves being operated sequentially to transfer wood chips down the column while providing cooking periods for extracting lignin;
(b) opening a containment valve disposed at the top of the counter current extraction column, above a valve housing a top level cooking chamber of the column, to feed wood chips to the top inlet;
(c) opening a containment valve downstream of valve that houses a bottom cooking chamber of the counter current extraction column, to remove pulp;
(d) separating the lignin from the black liquor; and
(e) recovering and recycling the solvent from the black liquor.

33. A method according to claim 32 in which the chambers and valves are arranged as a row performing essentially the identical process but in a different configuration.

34. An apparatus for processing plant biomass comprising:
(a) an extraction unit for extracting lignin from plant biomass;
(b) a high pressure bio-converter reactor for converting residue from the extraction unit;
(c) a plurality of pressure equalization cylinders fluidly connected to bio-converter;
(d) a control system for controlling valves proximate the bio-converter to rapidly open valves at the instant of minimum pressure difference between opposite sides of the valves; and
(e) a recovery section for recovering bio-crude from the hydrocarbon sludge by extraction.
